(19) United States
(12) Patent Application Publication
(10) Pub. No.: US 2023/0408238 A1
(43) Pub. Date: Dec. 21, 2023

(54) Construction Measuring Tool

(71) Applicant: Frank Ray, Rancho Santa Fe, CA (US)

(72) Inventor: Frank Ray, Rancho Santa Fe, CA (US)

(21) Appl. No.: 18/212,080

(22) Filed: Jun. 20, 2023

Related U.S. Application Data
(60) Provisional application No. 63/353,196, filed on Jun. 17, 2022.

(51) Int. Cl. G01B 3/20; G01B 3/06; G01B 5/14

(52) U.S. Cl. CPC G01B 3/20; G01B 3/06; G01B 5/14

(57) ABSTRACT

A measuring tool is provided which includes a sliding member which is in a rotational sliding engagement to the body of the tool. The sliding member is positionable for measuring distances between a first end thereof and a first body segment. A second body segment extends perpendicular from a first end of the first body segment and a third body segment extends at a 45 degree angle from a second end of the first body segment opposite the first end thereof.

This application claims priority to U.S. Provisional Patent Application Ser. No. 63/353,813 filed on Jun. 17, 2023, which is incorporated herein in its entirety by this reference thereto.

### BACKGROUND OF THE INVENTION

### 1. Field of the Invention

The present invention relates generally to construction, such as carpentry and the like and provides a tool employable to measure and to mark materials for cutting and to provide a user-formable offset guide surface whereby multiple substantially identical cuts may be achieved with a saw using the marks or offset guide surface.

### 2. Prior Art

In construction, a widely employed tool is the carpenter's square which is employed for measuring distance and angles and determining cutting lines and the like. Such a carpenter square, also sometimes known as a framing square or speed square, is a type of carpentry tool commonly used by carpenters, builders, and other home improvement aficionados. During construction, such as framing, a carpenter square gives the user the ability to measure and mark precise angled dimensions for complex projects like walls, doorways, roofs, rafters, stairways and other framing which requires precise measurements and subsequent cutting of materials.

Conventionally, carpenter's squares provide the user measuring and cut-marking components formed into a substantially triangular shaped device. Side edges on the body of the carpenter square allow for marking and cutting straight cut lines on lumber and for marking cut lines using slots.

Additionally provided, by conventional carpenter squares, are a combination of linear and angled edge surfaces. Some of the linear surfaces intersect at 90 degree angles to allow the user to mark the material for cutting to form perpendicular edges. Other formed edges on the body of conventional carpenter squares provide angled edges which allow for the tracing of cut lines to quickly mark 45 degree angles.

Formed into or imparted onto the body of conventional carpenter squares are also measurements, such as those employed upon tape measures and rulers. These depicted measurements allow the user to mark desired lines for material increments onto construction materials, such as wood or sheet rock, to allow for cutting them to desired sizes. Thereafter, using the lines or markings, the user employs a saw, such as a circular saw or table saw, to cut the materials to the correct size and correct angles.

The forgoing examples of related art in the field of conventional carpenter squares and the like, and limitation related therewith are intended to be illustrative and not exclusive, and they do not imply any limitations on the construction marking and measuring tool invention described and claimed herein. Various limitations of the related art will become apparent to those skilled in the art upon a reading and understanding of the specification below and the accompanying drawings.

### SUMMARY OF THE INVENTION

The measuring tool device herein disclosed and described provides significant enhancement to the art of measuring and marking materials employed for construction. Such materials, for example only and in no way limiting, include wood, metal, sheet rock, and similar construction materials used for buildings and are cut to size and angular dimensions using power saws, such as a circular saw or table saw.

The measuring tool device has a body formed of planar rigid material, such as metal, which will endure the hardships encountered by tools on a construction site. However, the body may also be formed of other materials, such as polymeric material or composites, to provide a light weight mode of the measuring tool herein.

The body has a first body segment extending from a first end thereof to a second end in a straight line. At the second end of the first body segment is positioned a second segment which is in a fixed engagement and which extends traverse to the axis of the first body segment at a 90 degree angle or perpendicular to the first body segment.

A third body segment extends from the first end of the first body segment. This third body segment extends at a 45 degree angle from the engagement thereof to the first segment as do both side edges of the third body segment.

Side edges are also located on opposing sides of the first body segment and upon the second body segment in addition to those of the third body segment. These side edges provide respective linear surfaces for purposes of running a marking instrument thereon, such as for example, a pencil or pen or ink marker. The side edges of the three body segments intersect to allow the user to use the marking instrument to thereby mark measured locations and lines upon the construction material for cutting and the like. The side edges of the second body segment run perpendicular to the side edges of the first body segment and the side edges of the third body segment run at a 45 degree angle to those of the first body segment.

Communicating through the first body segment is a first slot. Through this first slot is positioned a releasable connector, such as a screw and nut. The locking component is employable to fix the position of a sliding member which is removably positionable to different distances and rotated angled positions relative to the first body segment.

Measurement indicia is preferably positioned along one or both edges of the first body segment and the second body segment and the third body segment. The measurement indicia may be etched into the planar surfaces of the respective body segments or may be imparted thereon, such as by using ink or paint or the like. The measurement indicia, for example, may be in inches or other conventional markings for distance to provide the user the ability to mark distance upon the construction materials for positioning thereof or cutting thereof.

Particularly preferred, in all modes of the device herein, is the provision of a removable cutting edge portion along one side edge of the second body segment to allow the removable cutting edge portion to also operate as a depth gauge. This removable cutting edge portion is removably engaged to extend from the side edge of the second body segment. Such a removable engagement is preferred in the form of a slot or recess formed thereon which will removably connect with an engagement edge running along one side edge of the removable cutting edge portion.

The engagement edge, currently, is a formed elongated opening on an outside edge of the second body segment which is shaped to slidably engage with the engageable edge of the removable cutting edge. This engagement edge would be formed to a shape complimentary to the interior shape of the elongated opening.

The user can cut this removable cutting edge along a determined cut line which is a distance from the engageable edge or the opposite edge of the second body segment. This forms a cut line edge for use in a repeating cutting process for multiple construction components formed for the construction material. The user may run a saw blade along the formed cut line to cut material. This provides for high repeatable accuracy in the cutting and formation of multiple construction components. During use such a guide is provided for repeatable measuring and cutting. A sliding member employed for other measurements will be rotated out of the way of the removable cutting edge. The removable cutting edge portion may be replaced once the repeating cutting is finished to allow the user to form another cut line, or it may be removed to allow for use of both sides of the second body segment for measuring.

Preferably, the material forming the removable cutting edge is material which is substantially rigid to thereby maintain a straight cutting edge but which may easily be cut to form that straight edge. Such material, for example, may be plastic or polymeric or composite materials which are inexpensive but will hold a shape and edge, once engaged to the first body segment.

Because the removable cutting edge portion is slidably engaged with the second body segment, it may also be employed as a depth gauge or measuring tool. This is accomplished by sliding the removable cutting edge in its engagement with either the second body segment or one end of the removable cutting edge in contact with the surface of the material being measured. Where the removable cutting edge portion is slid, measurement indicia, located on the edge of the second body segment, will show the distance the removable cutting edge has been displaced thereby providing a depth measurement.

Particularly preferred in all modes of the device herein is a removably engageable sliding member. The sliding member has a second slot formed axially therein which communicates between a first planar side surface of the sliding member and a second planar side surface thereof. Formed into the second planar side surface of the sliding member is a recess which surrounds the second slot. This recess provides an elongated recessed area for positioning of a head portion of a screw which is employed to removably hold the sliding member in the sliding engagement with the first body segment of the device. The recessed positioning of the head of the screw is preferred in that it maintains a planar second side surface of the sliding members. This planar second side surface is positionable against or in contact with construction materials. Of course, another connector in a similar configuration to a screw having a head portion positionable in the second slot may be used and is anticipated.

At one end of the sliding member is located a ledge which projects from a lower surface and which is employable to contact against side surfaces of construction material. Once the ledge is in contact with the desired construction material, pulling or pushing upon the sliding member will slidingly reposition it relative to the body of the device herein. This repositioning allows for measuring and marking of the construction material as needed by the user.

The sliding member may be placed in a removable fixed engagement with the body of the device, such as in a compressed engagement against the first body segment. This compressed engagement is accomplished by a tightening of the nut engaged to the threaded end of the screw which communicates through the first slot in the first body segment. So positioned, the device can be employed for repeated marking of construction materials with highly accurate measurements, since the distance is fixed by the compressed engagement formed.

For such measurements and marking of construction materials, the sliding member can be rotated to multiple positions in a circle extending around the screw and nut forming the compressed engagement. In one of many such positions the ledge on the sliding member can be employed to contact around an edge of the material to be marked and cut and a distance from the end of the sliding member to a side surface of the first body segment can be employed. In another of such compressed engagement positions, the sliding member can be rotated to allow the outside edge of the ledge to contact against a side surface of construction material, and a distance can be marked therefrom to a position upon the first body segment.

The ledge can extend in a fixed position projecting from the lower surface of the sliding member, or in a particularly preferred mode of the device herein, the ledge is rotationally engaged to the end of the sliding member. In the rotational engagement, the ledge may be rotated into a recess. This forms a completely planar lower surface of the sliding member which is easier to rotate around the body of the device. The sliding member is rotatable to an infinite number of positions in a circle around the screw engaging it to the first body member.

The sliding member may also be used as a plumb bob to determine a straight and level plumb line. This is accomplished by loosening the compressive engagement of the sliding member against the first body segment and allowing it to drop under the force of gravity. The axis and side edges of the sliding member will naturally assume a plumb positioning to allow the user to check the plumb accuracy of an existing board or other construction material or to provide a visual reference to mark a plumb line thereon.

A third slot is formed parallel to the axis of the first body segment and communicates through the first body segment. This fourth slot is employable to mark the surface of the material being measured by the device. In a similar fashion a fourth slot communicates through the third body segment and runs at a 45 degree angle to the third slot in the first body segment. This fourth slot is employable to use a pencil or marker to mark lines and measurement points as well as to mark a 45 degree angle upon the material being measured relative to the two side surfaces and third slot sides running on the first body segment.

With respect to the above description, before explaining at least one preferred embodiment of the herein disclosed construction measuring tool invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other measuring structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. Finally, the term “substantially” if not otherwise defined, means plus or minus ten percent.

It is an object of this invention to provide a measuring tool which has multiple configurations and uses in measuring for cutting and forming materials employed for manufacturing and construction.

It is another object of this invention to provide a measuring device which can be used to mark or scribe measurements in a highly accurate and repeatable fashion.

It is a further object of this invention to provide such a cutting measuring device having a replaceable sacrificial cutting edge component which allows the user to form a cut line to guide a saw in a repeatable fashion along the formed cut line edge.

It is yet another object of this invention to provide a measuring tool which has a sliding member which is employable as a sliding ruler and measuring tool and is also configurable by rotation thereof to form a plumb bob.

Other objects, features, and advantages of the present measuring tool, as well as the advantages thereof over existing prior art, will become apparent from the description to follow, and are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features of the disclosed construction measuring tool. It is intended that the embodiments and figures disclosed herein are to be considered illustrative rather than limiting.

In the drawings:

FIG. 1 shows an overhead perspective view of the top or upper side surface of the body of the measuring tool device having the replaceable cutting edge portion connected to the engagement edge of a second body segment.

FIG. 2 depicts an overhead or top view of FIG. 1 of the body of the device herein.

FIG. 3 shows another side view, as in FIG. 2, depicting the body of the device having the cutting edge portion removed from the sliding engagement with one side of the second body segment and showing the sliding member positioned as a ruler or measuring tool to measure a distance for marking or cutting.

FIG. 4 shows a lower surface of the body of the device depicting the second slot formed through the sliding member and the recess surrounding it into which a head portion of the connector is positioned and the rotation around the connector achievable by the sliding member.

FIG. 5 depicts the sliding member extending as a ruler from one side of the body to allow for a measurement from the end of the sliding member having the projecting ledge to a position on the first body segment or second body segment.

FIG. 6 shows the device herein in a similar positioning to that of FIG. 5 wherein the sliding member has the projecting ledge of the sliding member contacts a surface of the construction material being measured.

FIG. 7 depicts the device wherein the sliding member is rotated to a reversed position having the first end with the ledge in contact against material being measured to allow for imparting line to the material in a fashion which is repeatable.

FIG. 8 shows a view of the device herein wherein the removable cutting edge portion is slidable to define a depth gauge.

FIG. 9 depicts an overhead view of the device herein where the sliding member is in a loose rotational engagement with the connector whereby it operates as a plumb bob.

FIG. 10 shows a lower or bottom view of the device herein wherein the ledge projects from a first end of the sliding member and showing the second slot surrounded by a recess into which the head of the connector is situated.

FIG. 11 shows the device herein, as in FIG. 10, where the projecting ledge is rotationally engaged to the first end of the sliding member and is positionable within a recess formed into the lower surface of the sliding member.

FIG. 12 shows the device with the sliding member removed configured to measure and mark angles upon the construction material using the head portion in contact therewith and one or a plurality of measurement indica located on the body segments.

Other aspects of the present measuring invention shall be more readily understood when considered in conjunction with the accompanying drawings, and the following detailed description, neither of which should be considered limiting.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device herein as it is oriented and appears in the drawings and are used for convenience only, and they are not intended to be limiting or to imply that the device has to be used or positioned in any particular orientation.

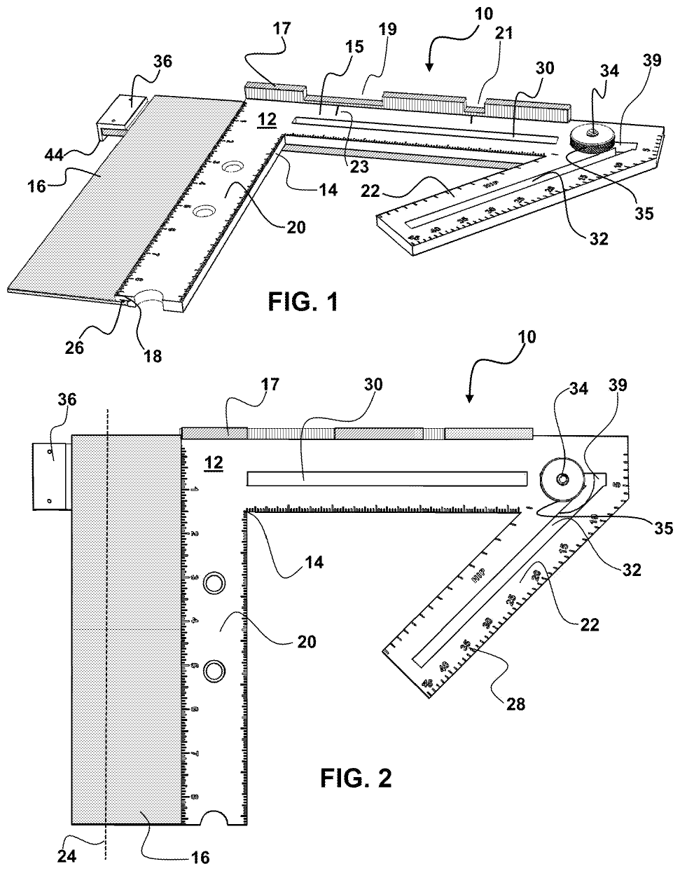

Now referring to drawings in FIGS. 1-12, wherein similar components are identified by like reference numerals, there is seen in FIGS. 1 and 2 overhead views of the top or upper side surface 12 of the body 14 of the measuring tool device 10 having a first body segment 15 connected at one end to a second body segment 20 and engaged at an opposite end to the third body segment 22.

The second body segment 20 extends perpendicular to the first body segment 15. The respective side edge on both sides of the second body segment 20 run perpendicular to the side edges on both sides of the first body segment 15.

The third body segment 22 runs at a 45 degree angle to the direction of the first body segment 15. The two side edges of the third body segment 22 also run at a 45 degree angle to the direction of both side edges of the first body segment 15.

As shown, a replaceable cutting edge portion 16 is slidably connected to the engagement edge 18 of a second body segment 20. As noted above, this replaceable cutting edge portion 15 is formed of material which is trimmable, and it may be cut by the user along cut line 24 to form a new edge used to guide a saw for repeatable cuts or to provide a measuring edge for a marker which is a defined distance from a user determined position on the body 14 of the device 10.

Thus, once the cutting edge portion 16 is severed along the cut line 24, the user may use the new edge along that cut line 16 for repeatable measurements to scribe or mark the material or to guide a saw for cuts upon construction material in a highly accurate repeatable fashion. The cutting edge portion 16 may be replaced with a new one, when needed.

As also noted above, the cutting edge portion 16 is preferably in a sliding engagement 26 with the engagement edge 18 of the second body segment 20. This can be accomplished, for example, by forming an engagement slot on the engagement edge 18 into which one side of the cutting edge portion 16 slidably engages. This sliding engagement is preferred, as noted, so as to allow the device 10 to function as a depth gauge, as in FIG. 8, whereby the width of material or the like can be measured using the measurement indicia 28 which is preferably located on side edges of the second body segment 20 as well as the first body segment 15 and the third body segment 22.

Optional but shown in FIG. 1 and other figures herein is a removable edge component 17 for board center determination. As shown, a first recess 19 and a second recess 21 is formed therein. A center mark 23 is situated adjacent each of the first and second recess and may be on the body of the device or upon the edge component 17. Currently, the first recess 19 is 3.5 inches wide and the second recess 21 is 1.5 inches wide which match the conventional width of board lumber for construction. This allows the user to position a board of either respective width into the recess into which it fits and easily view the center of the board, so inserted, using the adjacent center mark 23. The user can then easily mark or scribe the center to the lumber.

Also shown in FIGS. 1 and 2 and in other views of the device 10 herein are a third slot 30 formed through the first body segment 15 which has side edges which run parallel to an axis of the first body segment 15 as well as parallel to the two side edges of the first body segment. The third slot 30 is similar in configuration to the fourth slot 32 which communicates through the planar third body segment 22. This fourth slot 32 has side edges which run at a 45 degree angle relative to the side edges of the third slot 30. The side edges of the fourth slot 32 also run parallel to the side edges on opposing sides of the third body segment 22.

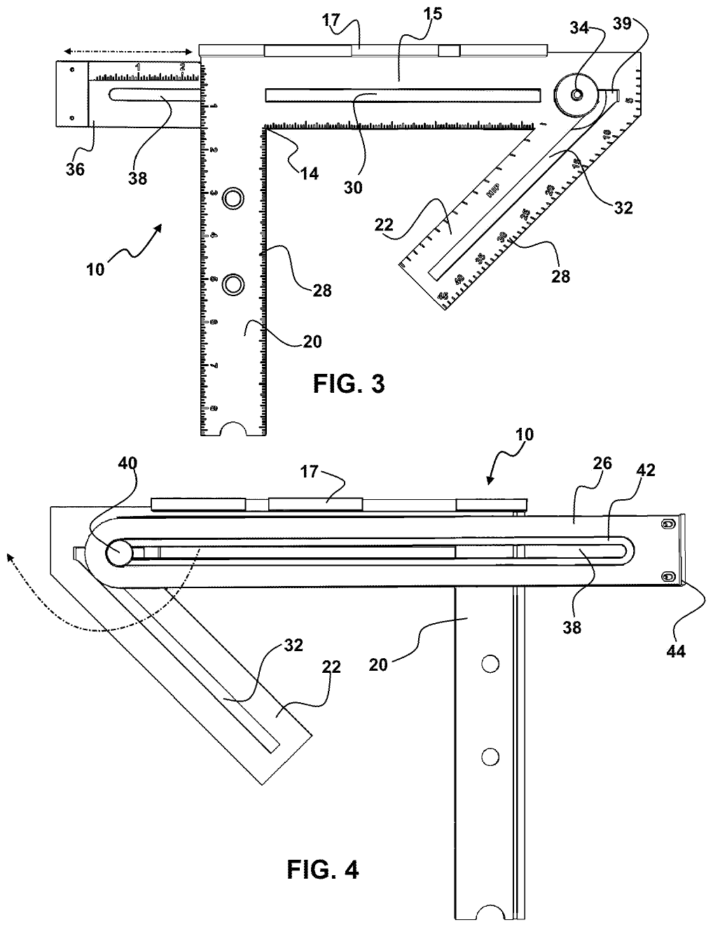

Also depicted in FIGS. 1 and 2 as well as in FIG. 3 are a releasable connector 34. This connector 34 is adjustable by the user from a loose configuration where the screw is loosened from the nut and wherein said sliding member 36 will slide and rotate thereon, to a tightened configuration wherein said sliding member 36 is forced to a compressive engagement against the body 14 such as against the lower surface of the first segment 15 of said body 14 to a removably fixed position of the sliding member 36.

As shown in FIGS. 3-4, the sliding member 36 has a second slot 38 through which the connector 34 is operatively positioned. The connector 34 also communicates through a first slot 19 which communicates through the first body segment 15 at a position adjacent to or preferably intersecting with the fourth slot 32 formed into the diagonal third body segment 22. In this operative positioning, a head 40 of the connector 34 is located within a recess 42 which surrounds the second slot 38. This is most preferred in order to provide a planar lower surface to the sliding member 36 to allow it to sit in a level fashion upon material being measured or cut.

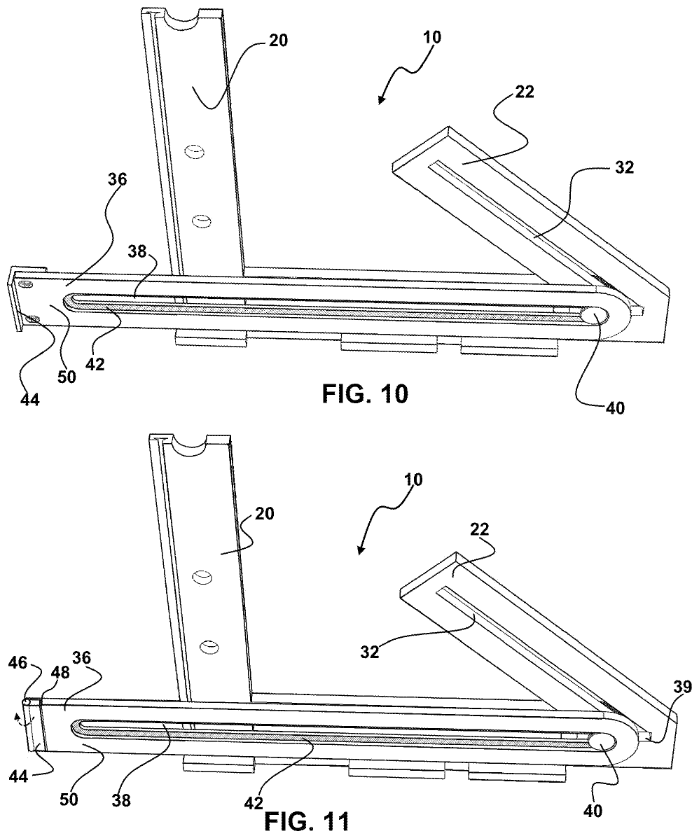

The sliding member 36 functions as a ruler and measurement tool which can be seen in FIGS. 3-6. In such an employment of the device 10, a first end of the sliding member 36 having a ledge 44 projecting therefrom, as shown in FIGS. 10-11. This ledge 44 can be in a fixed projection, as in FIG. 10, or may be in a rotating engagement 46 whereby it can be rotated between a first position where it projects from the lower surface of the sliding member 36, as in FIG. 10, and a second or retracted position where it is located within a formed ledge recess 48. In the retracted position, the lower surface 50 of the sliding member 36 is planar for the entire surface allowing for level contact with an underlying material 52 being marked, measured, or cut.

Shown in FIG. 4 is the lower surface of the body 14 of the device 10. As shown, the second slot 38 is shown formed through the sliding member 36. The second slot 38 has the recess surrounding it into which a head portion 40 of the connector 34 is positioned. The sliding member 36, as noted, is rotatable to an infinite number of angular positions relative to the body 14 by rotating it around the connector 34. As noted, the connector 34 is currently a threaded member having the head 40 on one end and having a nut 35 which may be hand tightened by the user to form the compressed engagement of the sliding member 36 against the body 14, such as against the first body segment 15 or against the other body segments depending on the angle of the sliding member 36 at the time.

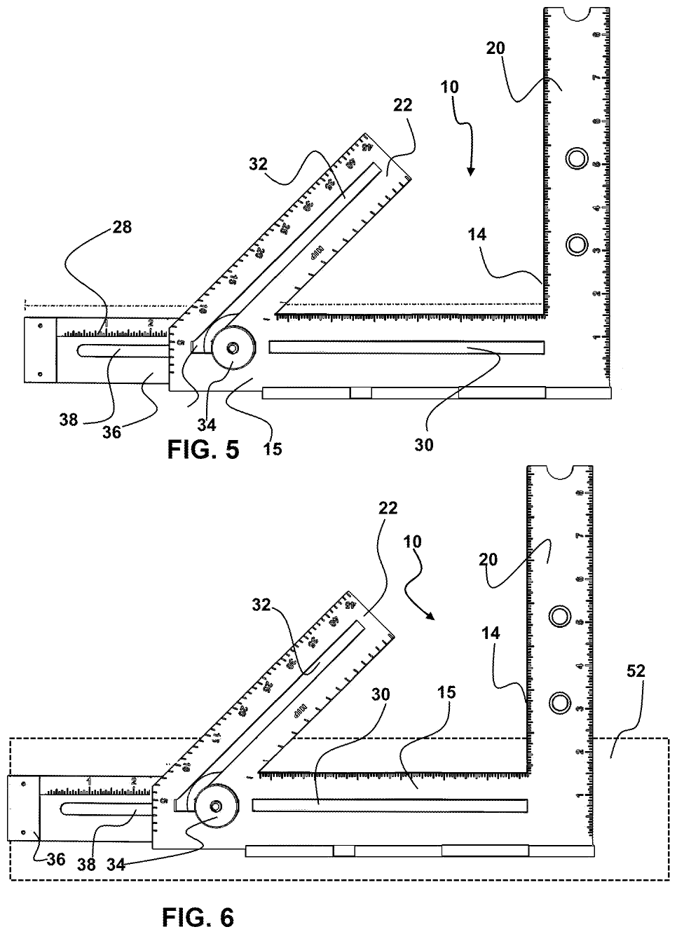

The sliding member 36 is shown in FIGS. 5-6 extending from one end of the first body segment 15 whereby measurements can be taken or marked. As shown, such measurements can be from the first end of the sliding member 36 having the ledge thereon to some other point on the body 14. With the connector 34 tightened to hold the sliding member 36 in the compressed contact against the body 14, this measurement, marking, or cut can be repeated with great accuracy.

Such measuring can be seen in FIG. 6, wherein the device 10 is in a similar positioning to that of FIG. 5. As shown, the sliding member 36 is in a first measuring configuration where the sliding member 36 has the projecting ledge 44 extending from the end of the first body segment 15 where it engages with the third body segment 22. In this first configuration, the ledge 44 or the first end of the sliding member 36 is in contact with a surface of the construction material 52. A measurement between the first end of the sliding member 36 to a determined point on the body segments can be determined, and the material 52 may be marked or cut at points which are repeatable.

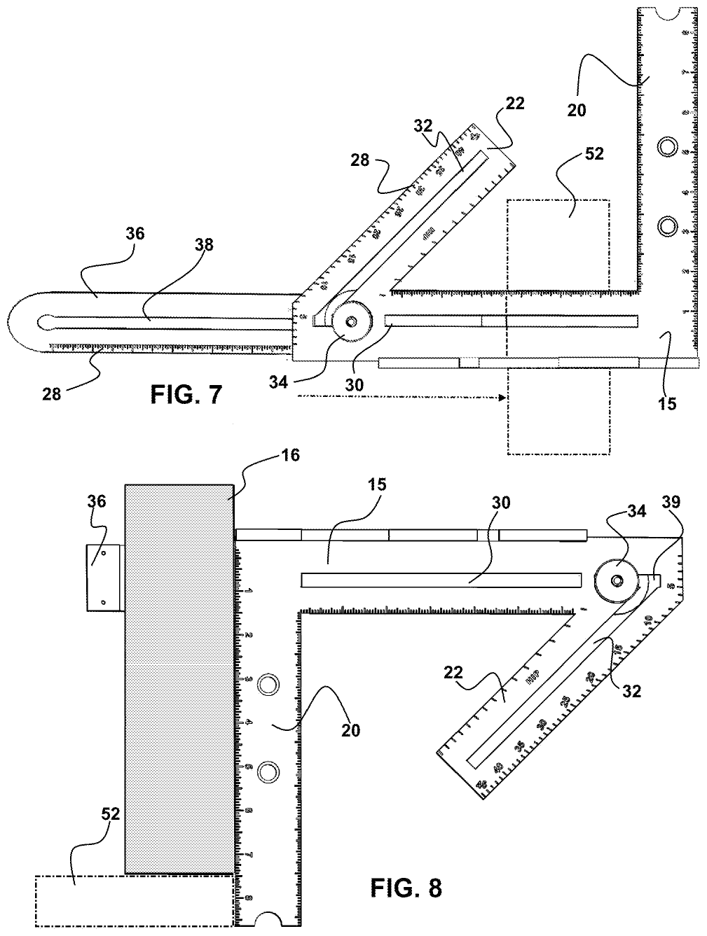

Shown in FIG. 7 is the device 10 herein, wherein the sliding member 36 is in a second configuration where it is rotated to a reversed position having the first end with the ledge 44 in contact against material 52 being measured to allow for imparting a scribe or line to the material 52 in a fashion which is repeatable. To repeat the positioning for a scribe or marking on another piece of material 52, the first end of the sliding member 36 is placed in contact therewith in the same fashion.

Depicted in FIG. 8 is a view of the device 10 herein, wherein the removable cutting edge portion 16 is slidable in the connection to the edge of the second body segment 20. This allows the device 10 to be employed as a depth gauge by using the measurement indicia 28 on the edge of the second body segment 20 as shown.

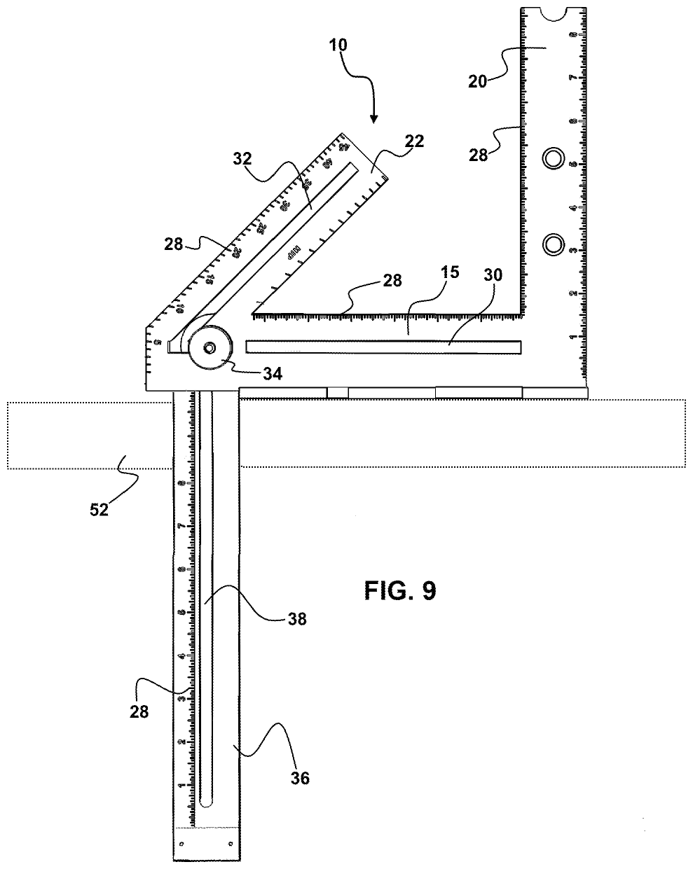

As noted and shown in FIG. 9, loosening the connector 34 to a point where the sliding member 36 will rotate freely thereon allows the device 10 herein to show or measure a plumb. This is because the sliding member 36 in free rotation will naturally settle to a vertical positioning due to gravity.

In FIG. 10 is shown a lower or bottom view of the body 14 of the device 10. As shown, the sliding member 36 has a ledge 44 on a first end thereof which is fixed and projects above a lower surface of the first end of the sliding member 36. Also shown is the second slot 38 surrounded by a recess 42 into which the head 40 portion of the connector 34 is situated.

The device, as shown in FIG. 11, is similar to that which is shown in FIG. 10. In FIG. 11, however, the projecting ledge 44 is rotationally engaged 46 to the first end of the sliding member 36, such as with a hinge, and is positionable within a ledge recess 48 formed into the lower surface 50 of the sliding member 36.

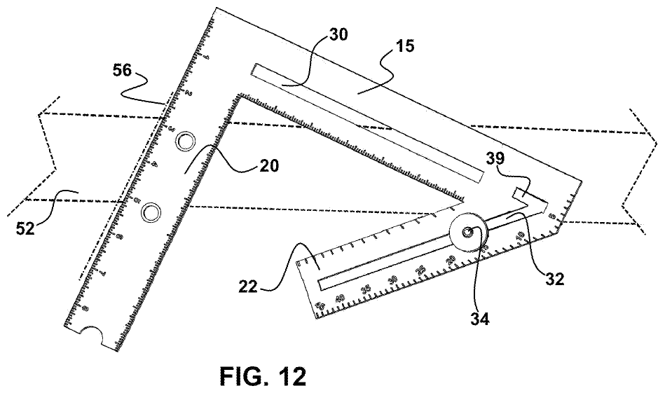

The device 10 herein is also configurable for marking or scribing angles to material 52 which is shown in FIG. 12. In this angle marking or determining configuration, the device 10 has the sliding member 36 removed. The connector 34 is in place within the fourth slot 32 which may communicate with the first slot 39 to allow for easy movement. In this configuration, the head 40 will project from the bottom of the body 14 and provide a contact point against the material 52. The body 14 may be rotated to position one or more points of the measurement indicia 28 in locations on the material 52 to determine an angle 56 which may be marked, scribed, or cut on the material 52. A repositioning of the device 10 upon another piece of material 52 of the same size and configuration will allow the user to repeat the marking or cutting on the same angle 56. Thus, the user can easily repeat the marking or cutting of an angle 56 with great accuracy on the material 52 being used.

This measuring invention has other applications, potentially, and one skilled in the art could discover these subsequent to reviewing this disclosure. The description of the features of this invention does not limit the claims of this application and other applications and equivalent configurations developed by those skilled in the art subsequent to reviewing this disclosure are intended to be included in this invention.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes of the disclosed measuring tool within the overall scope and intent of the invention, and are not to be considered limiting in any manner.

Further, while all of the fundamental characteristics and features of the measuring tool invention have been shown and described herein, with reference to particular embodiments thereof, a latitude of modification, various changes and equivalent substitutions are intended in the foregoing disclosure as well as the claims which follow, and it will be apparent that in some instances, some features of the invention may be employed without a corresponding use of other features without departing from the scope of the invention as set forth. It should also be understood that various substitutions, modifications, and equivalent variations may be made by those skilled in the art subsequent to review of this disclosure without departing from the spirit or scope of the invention. Consequently, all such modifications and variations and substitutions are included within the scope of the invention as defined by the following claims.

What is claimed is:

1. A measuring tool apparatus, comprising:
a planar body, said body having a first segment;
said body having a second segment extending from a first end of said first segment, said second segment being perpendicular to said first segment;
said body having a third segment extending from a second end of said first segment, said third segment extending in a direction toward said second segment at a 45 degree angle;
a first slot communicating through said first segment from a top surface thereof to a lower surface thereof;
a sliding member, said sliding member extending between a first end and second end thereof and having an elongated second slot communicating therethrough;
a connecter engaged through said first slot and said second slot; and
said connector being adjustable from a loose configuration wherein said sliding member will slide and rotate thereon, to a tightened configuration wherein said sliding member is in a compressive engagement against said first segment of said body to a removably fixed position.

2. The measuring tool apparatus of claim 1, additionally comprising:
a ledge extending from a lower surface of said sliding member opposite an upper surface thereof which contacts said body in said compressive engagement; and
said ledge for engaging on a surface of material being measured wherein a distance of said material is measurable using measurement indicia located on one or both of said first segment of said body and said sliding member.

3. The measuring tool apparatus of claim 1, additionally comprising:
a cutting edge portion having a first edge and a second edge;
said cutting edge portion having said first edge removably engaged to an engagement edge of said second segment of said body; and
said cutting edge being trimmable adjacent said second edge thereof to form a marking edge for imparting a cut line to material being measured.

4. The measuring tool apparatus of claim 2, additionally comprising:
a cutting edge portion having a first edge and a second edge;
said cutting edge portion having said first edge removably engaged to an engagement edge of said second segment of said body; and
said cutting edge being trimmable adjacent said second edge thereof to form a marking edge for imparting a cut line to said material being measured.

5. The measuring tool apparatus of claim 3, additionally comprising:
said first edge of said cutting edge portion in a sliding engagement with said engagement edge of said second segment of said body;
said measurement indicia being located along said engagement edge of said second segment of said body; and
a sliding of said cutting edge portion defining a depth gauge.

6. The measuring tool apparatus of claim 4, additionally comprising:
said first edge of said cutting edge portion in a sliding engagement with said engagement edge of said second segment of said body;
said measurement indicia being located along said engagement edge of said second segment of said body; and
a sliding of said cutting edge portion defining a depth gauge.

7. The measuring tool apparatus of claim 1, additionally comprising:
said sliding member rotatable upon said connector while in said loose configuration; and
said connector employable as a plumb bob.

8. The measuring tool apparatus of claim 2, additionally comprising:
said sliding member rotatable upon said connector while in said loose configuration; and
said connector employable as a plumb bob.

9. The measuring tool apparatus of claim 3, additionally comprising:
said sliding member rotatable upon said connector while in said loose configuration; and
said connector employable as a plumb bob.

10. The measuring tool apparatus of claim 4, additionally comprising:
said sliding member rotatable upon said connector while in said loose configuration; and
said connector employable as a plumb bob.

11. The measuring tool apparatus of claim 5, additionally comprising:
said sliding member rotatable upon said connector while in said loose configuration; and
said connector employable as a plumb bob.

12. The measuring tool apparatus of claim 6, additionally comprising:
said sliding member rotatable upon said connector while in said loose configuration; and
said connector employable as a plumb bob.

13. The measuring tool apparatus of claim 1, additionally comprising:
an elongated third slot communicating through said first segment of said body;
an elongated fourth slot communicating through said third segment of said body;
said elongated fourth slot running at a 45 degree angle relative to said elongated first slot; and
said first slot in communication with said elongated fourth slot wherein said connector is positionable within said fourth slot.

14. The measuring tool apparatus of claim 2, additionally comprising:
an elongated third slot communicating through said first segment of said body;
an elongated fourth slot communicating through said third segment of said body;
said elongated fourth slot running at a 45 degree angle relative to said elongated first slot; and
said first slot in communication with said elongated fourth slot wherein said connector is positionable within said fourth slot.

15. The measuring tool apparatus of claim 3, additionally comprising:
an elongated third slot communicating through said first segment of said body;
an elongated fourth slot communicating through said third segment of said body;
said elongated fourth slot running at a 45 degree angle relative to said elongated first slot; and
said first slot in communication with said elongated fourth slot wherein said connector is positionable within said fourth slot.

16. The measuring tool apparatus of claim 4, additionally comprising:
an elongated third slot communicating through said first segment of said body;
an elongated fourth slot communicating through said third segment of said body;
said elongated fourth slot running at a 45 degree angle relative to said elongated first slot; and
said first slot in communication with said elongated fourth slot wherein said connector is positionable within said fourth slot.

17. The measuring tool apparatus of claim 5, additionally comprising:
an elongated third slot communicating through said first segment of said body;
an elongated fourth slot communicating through said third segment of said body;
said elongated fourth slot running at a 45 degree angle relative to said elongated first slot; and
said first slot in communication with said elongated fourth slot wherein said connector is positionable within said fourth slot.

18. The measuring tool apparatus of claim 6, additionally comprising:
an elongated third slot communicating through said first segment of said body;
an elongated fourth slot communicating through said third segment of said body;
said elongated fourth slot running at a 45 degree angle relative to said elongated first slot; and
said first slot in communication with said elongated fourth slot wherein said connector is positionable within said fourth slot.

19. The measuring tool apparatus of claim 11, additionally comprising:
an elongated third slot communicating through said first segment of said body;
an elongated fourth slot communicating through said third segment of said body;
said elongated fourth slot running at a 45 degree angle relative to said elongated first slot; and
said first slot in communication with said elongated fourth slot wherein said connector is positionable within said fourth slot.

20. The measuring tool apparatus of claim 12, additionally comprising:
an elongated third slot communicating through said first segment of said body;
an elongated fourth slot communicating through said third segment of said body;
said elongated fourth slot running at a 45 degree angle relative to said elongated first slot; and
said first slot in communication with said elongated fourth slot wherein said connector is positionable within said fourth slot.
